(19) United States
(12) Patent Application Publication
(10) Pub. No.: US 2005/0225648 A1
(43) Pub. Date: Oct. 13, 2005

(54) Image extraction method and image capture device utilizing the same

(75) Inventors: Jing-Shun Lin, Wujie Township (TW); Chao-Lien Tsai, Jhushan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/077,844

(22) Filed: Mar. 11, 2005

(30) Foreign Application Priority Data
Apr. 8, 2004 (TW) 93109716

(51) Int. Cl. H04N 5/228

(52) U.S. Cl. 348/222.1

(57) ABSTRACT

A specific image extraction method implemented in an image capture device. First, a second image and a first image containing a subject are captured. Next, a third image is obtained by evaluating the difference between the first image and second image. A fourth image is acquired by performing edge enhancement on the third image. A contour is drawn from the fourth image, and adjusted. The subject is extracted based on the adjusted contour. The extracted subject is displayed using an application executed in the image pickup device.

### BACKGROUND

The invention relates to image processing, and in particular to a method of extracting a specific portion of a captured image and an image capture device utilizing the same.

Digital still cameras have become increasingly popular. Typically, a display is provided on a digital still camera, through which not only images can be shown but also other entertainment features, such as video games, can be provided.

Using an image capture feature, a camera may provide various entertainment features. Since digital still cameras do not yet combine image capture features with gaming capability, some problems thereof are encountered. The following description illustrates some situations.

A scene where a subject exists is referred to as a background. Figures of subjects may be various, but frames of all images captured by a camera are typically limited to the same shape, such as a rectangular, thus, a captured image may typically comprise a subject and background.

A captured image comprising a subject and background is less flexible for use, for example, when a sports car is pictured and intended to replace a car image in a racing game program, images of the sports car and background thereof included in a captured image are imported into the racing game program to replace the original car. Racing games, however, typically comprise animated scenes of a racetrack. If the captured image consists of a rectangular image, the image of the background included in the rectangular image blocks the view animated scenes in the racing game program, thus reducing the realism of the racing game.

Additionally, when a subject is captured as an image to replace an element, such as a cursor, of graphical user interface (GUI) of a camera, the captured image comprises images of the subject and background is less flexible.

Hence, there is a need for an image processing method capable of solving the above-described problems.

### SUMMARY

Accordingly, embodiments of the invention provide an image extraction method, implemented in an image capture device. A first image and a second image are captured. Only the first image comprises a subject. A third image is generated from the difference between the first and the second image. Edges of the third image are enhanced to generate a fourth image. A contour is extracted from the fourth image. The contour is adjusted. The subject is extracted based on the adjusted contour. The extracted subject is displayed using an application executed in the image capture device.

Embodiments of the invention further provide a specific image extraction method, implemented in an image capture device comprising a touch panel and an application. A first image comprising a subject is captured. A contour related to the subject is acquired through the touch panel. The subject is extracted based on the contour. The extracted subject is displayed using the application executed in the image capture device.

The specific image extraction method of embodiments of the invention may be implemented in a computer program stored in a storage medium which, when executed, directs an image capture device to perform the image extraction method.

Additionally, embodiments of the invention provide an image capture device comprising an image capture unit, a processing unit, and a display. The image capture unit captures a first image and a second image, wherein only the first image comprises a subject. The processing unit coupled to the image capture unit generates a third image from the difference of the first and the second image, enhances edges of the third image to generate a fourth image, extracts a contour from the fourth image, adjusts the contour, and extracts the subject based on the adjusted contour. The display coupled to the processing unit displays the extracted subject using an application executed in the image capture device.

Embodiments of the invention also provide an image capture device, comprising an image capture unit, a touch panel, a processing unit, and a display. The image capture unit captures a first image comprising a subject. The touch panel provides a contour of the subject according to user operation. The processing unit coupled to the image capture unit and the touch panel acquires the contour from the touch panel and extracts the subject based on the contour. The display coupled to the processing unit displays the extracted subject utilizing an application executed in the image capture device.

### DESCRIPTION OF THE DRAWINGS

Embodiments of the invention can be more fully understood by reading the subsequent detailed description and examples with references made to the accompanying drawings, wherein:

FIG. 1 is a block diagram of the configuration of a digital camera of an embodiment of the invention;

FIG. 2 is a flowchart of the image extraction method according to an embodiment of the invention;

FIG. 3 is a flowchart of image extraction steps in detail according to a first embodiment of the invention;

FIG. 4 is a flowchart of image capture steps in detail according to a second embodiment of the invention;

FIG. 5 is a flowchart of image extraction steps in detail according to the second embodiment of the invention;

FIG. 6 is a schematic diagram of pixel distribution in the second embodiment of the invention;

FIG. 7 is a schematic diagram of collecting edge sample pixels according to the second embodiment of the invention;

FIG. 8 is a schematic diagram of four separated edge sample pixels in the second embodiment of the invention;

FIG. 9 is a schematic diagram of a search area according to the second embodiment of the invention;

FIG. 10 is a schematic diagram of an exemplary image comprising a subject in the second embodiment of the invention;

FIG. 11 is a schematic diagram of an exemplary image without the subject in the second embodiment of the invention;

FIG. 12 is a schematic diagram of an exemplary foreground-enhanced image in the second embodiment of the invention;

FIG. 13 is a schematic diagram of an exemplary edge-enhanced image in the second embodiment of the invention;

FIG. 14 is a schematic diagram of exemplary collected edge sample pixels in the second embodiment of the invention;

FIG. 15 is a schematic diagram of an exemplary rough contour 13 in the second embodiment of the invention;

FIG. 16 is a schematic diagram of an exemplary adjusted contour 16 in the second embodiment of the invention;

FIG. 17 is a schematic diagram of an exemplary extracted specific image in the second embodiment of the invention; and

FIG. 18 is a schematic diagram of the storage medium according to embodiments of the invention.

### DETAILED DESCRIPTION

Embodiments of the invention provides a specific image extraction method implemented in an image capture device, such as a digital still camera, for extracting a specific image area from a preserved or recently captured image, and providing the specific image area subsequently to any application unit.

The image extraction method of the invention may be implemented in various image capture devices, such as a mobile communication device with a built-in camera, video camera or other electronic image capture devices. Preferably, the image extraction method of the invention is implemented in mobile devices, such as a mobile communication device with a built-in camera or portable digital camera. A digital camera is provided as an example of an image capture device in the following description. Noted that the example is not intended to limit the invention.

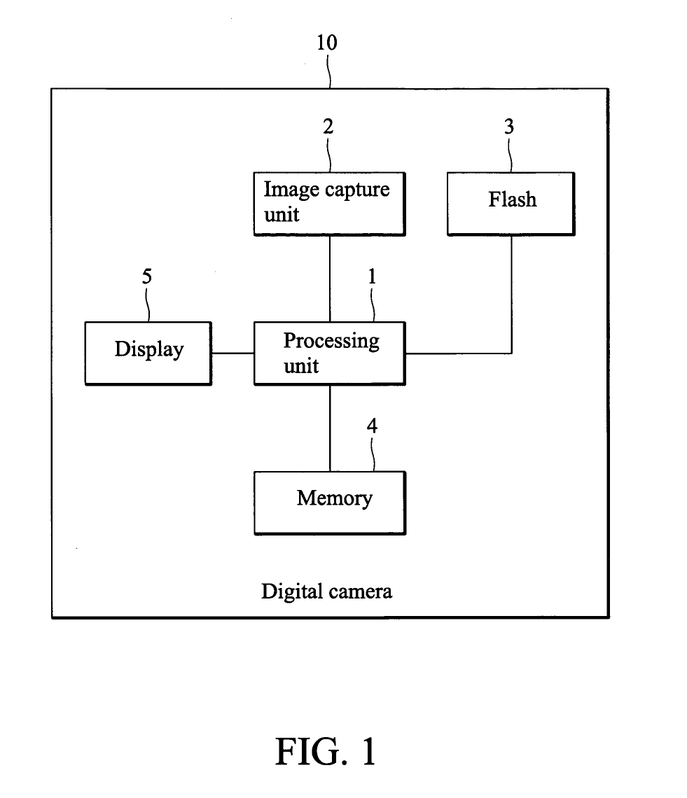

FIG. 1 is a block diagram of the configuration of a digital camera 10 in an embodiment of the invention. Digital camera 10 comprises processing unit 1, image capture unit 2, flash 3, memory 4 and display 5. Processing unit 1 is coupled to image capture unit 2, flash 3, memory 4 and display 5. Image capture unit 2 captures images. Flash 3 emits light to assist in image capture. Memory 4 stores digital image data and a plurality of applications. Display 5 presents images stored in memory 4 and the GUI of the applications and operating system of digital camera 10.

Embodiments of the invention, two specific image extraction processes, one manual and the other automatic, can be utilized to extract a image from a still image. These two image extraction methods are described in detail respectively in the following.

### First Embodiment

In the first embodiment of the invention, an image capture device capable of manual extraction of a specific image must comprise a touch screen, a touch panel or similar. In the first embodiment of the invention, display 5 in FIG. 1 is described as a touch screen but is intended to limit the invention.

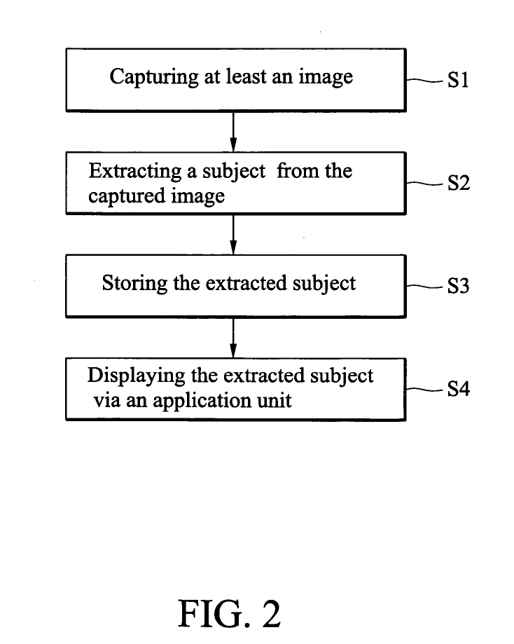

FIG. 2 is a flowchart of the image extraction method according this embodiment of the invention. After selecting the manual process, the digital camera is used to capture images 10. Specifically, processing unit 1 captures a first image comprising a subject via image capture unit 2 (step Si). Next, processing unit 1 extracts the subject according to user operation of the touch screen (step S2).

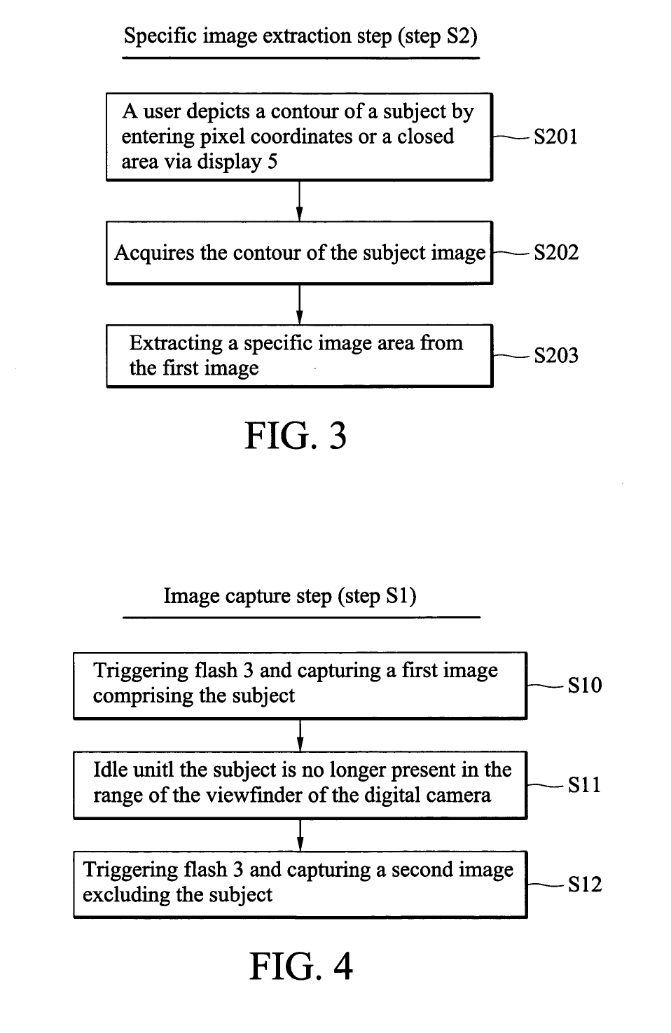

FIG. 3 is a flowchart of step S2 in detail according to the first embodiment of the invention. Pixel coordinates or a closed area are input via display 5 to depict a contour of the subject (step S201). Processing unit 1 acquires the pixel coordinates or the closed area (step S202) and thereby extracts a specific image area from the first image (step S203). Specifically, processing unit 1 determines the range of the pixel coordinates or closed area, adopts the image area (pixels) enclosed by the range as the subject, and clears the image area (pixels) excluded from the range, which are determined to be background.

Processing unit 1 stores the extracted subject in memory 4 (step S3) for subsequent use. Processing unit 1 can retrieve and display the subject by executing a specific application when requested (step S4).

The first embodiment provides the advantageous functionality of user-defined subject range determination, implementation thereof, however, requires a touch screen or similar.

### Second Embodiment

When the user selects the automatic image extraction process, processing unit 1 performs the following steps. In the second embodiment of the invention, image extraction method is implemented by, but not limited to, a program stored in memory 4. For example, the following steps or portions thereof may be implemented in circuits.

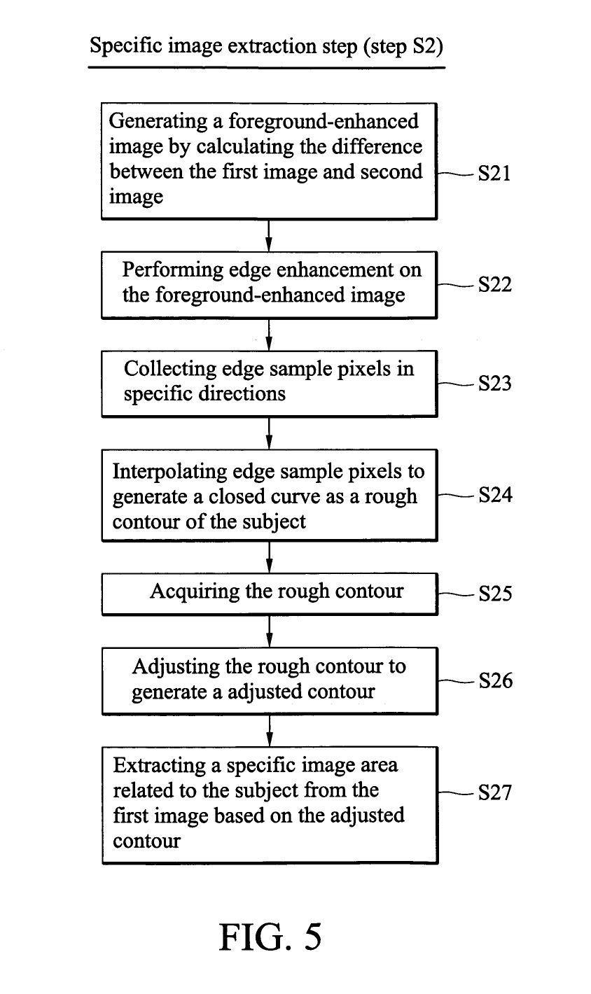

FIGS. 2, 4 and 5 are referred in the following description. The automatic image extraction process in the second embodiment is roughly identical to FIG. 2 with the exception of implementation of steps S1 and S2. FIG. 4 is a flowchart of step S1 in detail according to the second embodiment of the invention. FIG. 5 is a flowchart of step S2 in detail according to the second embodiment of the invention.

In image capture step S1, as shown in FIG. 4, digital camera 10 captures at least two images related to a background. For example, the digital camera 10 is located in a specific position, such as fixed on a tripod or set on a table. When a subject enters the range of a viewfinder of digital camera 10, processing unit 1 triggers flash 3 and captures a first image comprising the subject and the background via image capture unit 2 (step S10). Digital camera 10 is then idle until the subject is no longer present in the range of the viewfinder of digital camera 10 (step S11). Digital camera 10 may be idle for a predefined period of time, for example, 10 seconds. When digital camera 10 remains the original position, processing unit 1 triggers flash 3 again and captures a second image excluding the subject via image capture unit 2 (step S12).

When the digital camera 10 is fixed in the specific position for capturing the first and second images, background images can be easily removed, for example, by subtracting the second image from the first image even if the background is complex. Note that the arrangement is not intended to limit the invention. For example, digital camera 10 may be located in different locations respectively to capture the first and second images. When capturing images comprising a uniform-color background, such as a wall or curtain, digital camera 10 can easily extract subjects thereof even if the position of digital camera 10 is changed. Additionally, image capture order may be changed. For example, the first image may be captured subsequent to the second image. When capturing images, digital camera 10 triggers the flash to eliminate noise and unify background color if necessary.

FIG. 5 is a flowchart of the subject extraction step S2 in detail.

First, processing unit 1 generates a foreground-enhanced image by calculating the difference between the first image and second image both captured in step S1 (step S21), only maintaining difference bigger than a threshold value. Processing unit 1 subtracts primary color values of the second image from the corresponding first image to generate the foreground-enhanced image. If a pixel color difference is smaller than the threshold value, processing unit 1 resets the difference as zero. Conversely, if a pixel color difference is larger than the threshold value, processing unit 1 resets the difference to the absolute value thereof. The threshold value is set to eliminate remaining background image pixels after the subtraction, which would be treated as subject pixels. Because noise may generate the remaining pixels of the background after the subtraction, the threshold value may be determined according to noise intensity.

For example, the threshold values of all three primary colors (i.e. red, green and blue, RGB) are “30”, the primary color values (R, G, B) of a pixel of a first image and a corresponding pixel of a second image are (130, 60, 90) and (110, 50, 80), the respectively. The absolute value of the difference of the two pixels is (20, 10, 10), the individual value of which is less than the threshold value. Thus, processing unit 1 determines these two pixels to be a part of background image and resets the difference to be (0, 0, 0). Conversely, if the primary color values (R, G, B) of another pixel of the first image and a pixel of the second image corresponding thereto are (130, 60, 90) and (10, 15, 20) respectively. The absolute value of the difference between the two pixels is (120, 45, 70) an individual value more than the threshold value. Thus, processing unit 1 determines the difference to be the primary color values of a pixel of the foreground-enhanced image corresponding to the first pixel of the image.

If located in a different position when capturing the first and second images, digital camera 10 may align the first and second images by shifting or whirling before the subtraction, so that background image can be approximately removed after the subtraction.

The foreground-enhanced image requires further image processing for generating a proper contour of the subject. In the second embodiment of the invention, the processing unit 1 performs edge enhancement on the foreground enhanced image (step S22), collects edge sample pixels (step S23), interpolates edge sample pixels to a closed curve as a rough contour of the subject (step S24), acquires (step S25) and adjusts (step S26) the rough contour, and extracts specific pixels related to the subject based on the adjusted contour from the first image (step S27). Steps S22-S27 are described in the following.

In the second embodiment of the invention, edges of the foreground-enhanced image are further enhanced to generate an edge-enhanced image using the Laplacian and the Sobel algorithms. The Laplacian algorithm enhances a central pixel within a Laplacian mask. The Sobel algorithm enhances vertical or horizontal edges. The Laplacian and the Sobel operation are both implemented on the foreground enhanced image to achieve preferred edge detection.

The Laplacian operation searches zero-crossings in the second derivative of the foreground-enhanced image to find edges. The Laplacian operation can be implemented using several digital filters. In the second embodiment of the invention, Laplacian operator comprises a 3×3 mask:

$$[ \begin{matrix}0 & - 1 & 0 \\ - 1 & 4 & - 1 \\ 0 & - 1 & 0\end{matrix} ] .$$

A Laplacian operation is applied to the brightness value of every pixel within the foreground enhanced image to generate a first edge-enhanced image. Note that the mask is not intended to limit the invention. In practice, the edge enhancement step can use a mask of which a parameter corresponding to a central pixel therein comprises a positive value (such as “4” in the mask of the second embodiment) and parameters corresponding to pixels surrounding the central pixel comprise a negative or zero value (such as “−1” and “0” in the mask of the second embodiment).

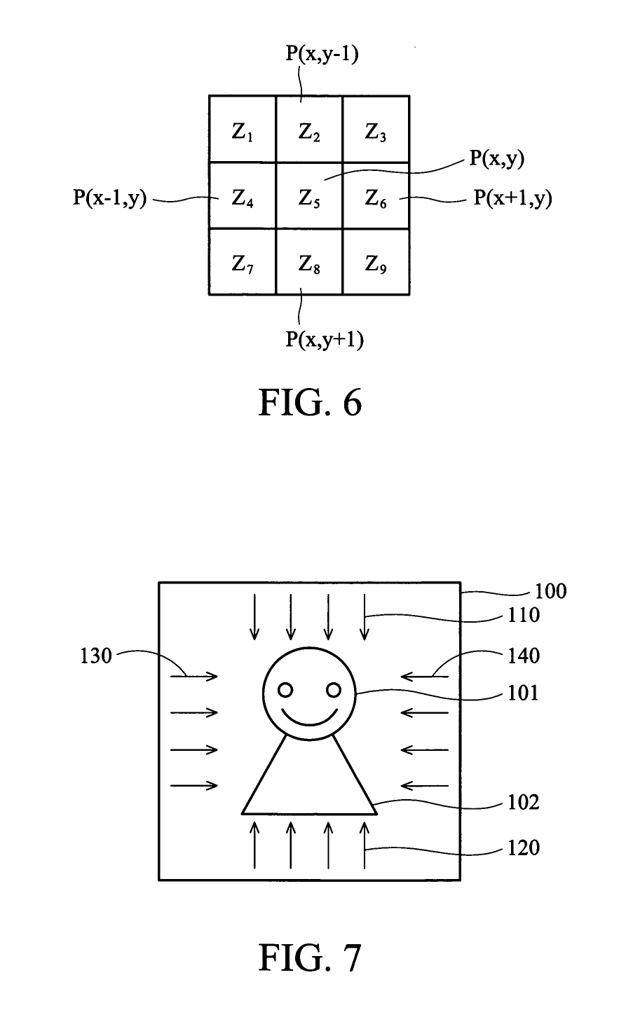

For example, processing unit 1 performs the Laplacian operation to a pixel P(x, y) of the foreground-enhanced image. FIG. 6 is a schematic diagram of pixel distribution. The brightness value zᵢ (i=1˜9) of pixels in FIG. 6 are determined by:
zᵢ=0.2990×Rᵢ+0.5870×Gᵢ+0.1140×Bᵢ (1)

Rᵢ, Gᵢ and Bᵢ are red, green and blue color values of a specific pixel. The brightness values of the pixel P(x, y) and eight other pixels surrounding the pixel P(x, y) are processed are adopted as input of the Laplacian operation of the pixel P(x, y), the result of which is:
f_{LAP}(P)=4z₅−(z₂+z₄+z₆+z₈). (2)

The z₅ is the brightness value of the pixel P(x, y), and z₂, z₄, z₆ and z₈ are brightness value of the pixels (x, y−1), (x−1, y), (x+1, y) and (x, y+1) respectively. After performing the Laplacian operation on every pixel in the foreground enhanced image, processing unit 1 acquires the first edge-enhanced image.

Gradient vectors reflect directions and intensity of image variation, wherein intensity is approximated as:
∇P(x, y)=|Gₓ|+|G_{y}| (3)

In the second embodiment of the invention, the Sobel operation is implemented to the foreground-enhanced image to generate a second edge-enhanced image using two Sobel 3×3 masks comprising:

$$[ \begin{matrix}- 1 & - 2 & - 1 \\ 0 & 0 & 0 \\ 1 & 2 & 1\end{matrix} ] and [ \begin{matrix}- 1 & 0 & 1 \\ - 2 & 0 & 2 \\ - 1 & 0 & 1\end{matrix} ] .$$

When processing unit 1 performs the Sobel operation on the pixel P(x, y) in the foreground-enhanced image, the result of which is:

$$\begin{matrix}{f}_{Sobel} ( P ) = \vert {G}_{x} \vert + \vert {G}_{y} \vert \\ = \vert ( {z}_{7} + 2 {z}_{8} + {z}_{9} ) - ( {z}_{1} + 2 {z}_{2} + {z}_{3} ) \vert + \\ \vert ( {z}_{3} + 2 {z}_{6} + {z}_{9} ) - ( {z}_{1} + 2 {z}_{4} + {z}_{7} ) \vert .\end{matrix} \qquad ( 4 )$$

The z₁, z₂, z₃, z₄, z₅, z₆, z₈ and z₉ are brightness values of the pixels (x−1, y−1) (x, y−1), (x+1, y−1), (x−1, y), P(x, y), P(x+1, y), (x−1, y+1) (x, y+1) and (x+1, y+1). After performing the Sobel operation on every pixel of the foreground-enhanced image, processing unit 1 acquires a second edge-enhanced image. Note that that |Gₓ| and |G_{y}| enhance edges perpendicular to axis x and y respectively.

Next, processing unit 1 combines the first and second edge-enhanced images. In the second embodiment of the invention, processing unit 1 adds the first and second edge-enhanced images, weighted with respective first and second weight values, to generate a third edge-enhanced image. The first and second weight values may be adjusted Although using the Laplacian and the Sobel algorithm as previously described, edge enhancement steps of the second embodiment of the invention, can employ one of them or another edge enhancement algorithm.

In the edge enhancement steps, not only outline edges but inner feature edges of the subject, such as the eyes or mouth of a person, is enhanced. Processing unit 1, therefore, performs the following edge collection step S23 to collect outline edges of the subject. First, processing unit 1 determines the central point of the third edge-enhanced image derived from resolution thereof. For example, when an image was a resolution of 2048×1536, the central point thereof may be (1024, 768). Next, processing unit 1 collects edge sample pixels in specific directions from an outer portion to the central point of the third edge-enhanced image. Thus, processing unit 1 can determine and separate outline edge pixels from the inner feature edges of the subject.

FIG. 7 is a schematic diagram for collecting edge sample pixels. The subject of the edge-enhanced image 100 comprises a circle portion 101 and a triangle portion 102. Each pixel of the edge-enhanced image 100 reflects an individual brightness value, and the majority of the background pixels are reset to zero brightness values.

Processing unit 1 collects edge sample pixels from every pixel column from the least x coordinate value to the greatest x coordinate value. For each pixel column, processing unit 1 collects edge sample pixels in two directions, one from upper to lower (direction 110) and the other form lower to upper (direction 120). In a specific direction, when first acquiring a pixel with brightness value more than a second threshold value, processing unit 1 collects the pixel as an edge sample pixel. Similarly, processing unit 1 collects edge sample pixels of every pixel row from the least y coordinate value to the greatest y coordinate value. For each pixel row, processing unit 1 collects edge sample pixels in two directions, one from left to right (direction 130) and the other from right to left (direction 140). In a specific direction, when first acquiring a pixel with brightness value more than the second threshold value, processing unit 1 collects the pixel as an edge sample pixel.

The second threshold value is determined according to image characteristics by experiments. Basically, the second threshold value is set for separating the edge of the subject from the background. In an example of a brightness value range “0256”, the exemplary second threshold value may be “70”. Referring to FIG. 7, the collected edge sample pixels comprise the outline of the circle and triangle portion but exclude overlapping edges thereof and inner features of the circle portion 101.

The described edge collection step is performed to collect edge sample pixels near the contour of the subject. Various amendments may be implemented to the edge collection step.

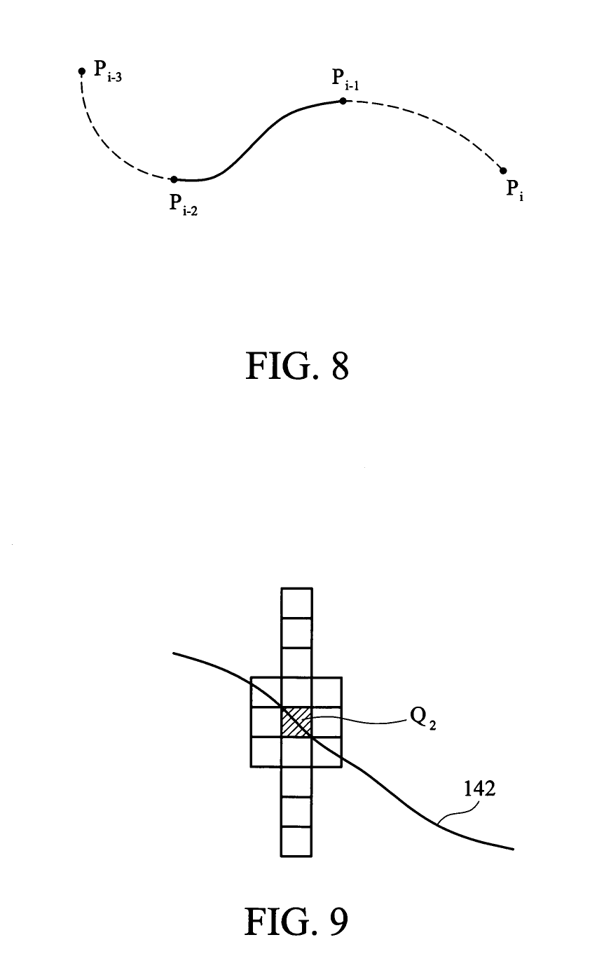

Edge sample pixels acquired in the edge collection step S23 are adopted to draw a closed curve as the contour of the subject. In the second embodiment of the invention, processing unit 1 interpolates the edge sample pixels to generate a spline. FIG. 8 is a schematic diagram of four separated edge sample pixels. A spline between two edge sample pixels Pᵢ₋₁ and Pᵢ₋₂ is generated based on a curve function derived from these two edge sample pixels and two neighboring edge sample pixels Pᵢ₋₃ and Pᵢ. The curve function may be represented as the following:

$$\begin{matrix}{Q}_{i} [ t ] = {TMG}_{i} , wherein & ( 5 ) \\ T = [ \begin{matrix}{t}^{3} & {t}^{2} & {t}^{1} & 1\end{matrix} ] , & ( 6 ) \\ M = \frac{1}{2} [ \begin{matrix}- 1 & 3 & - 3 & 1 \\ 2 & - 5 & 4 & - 1 \\ - 1 & 0 & 1 & 0 \\ 0 & 2 & 0 & 0\end{matrix} ] , and & ( 7 ) \\ {G}_{i} = {[ \begin{matrix}{P}_{i - 3} & {P}_{i - 2} & {P}_{i - 1} & {P}_{i}\end{matrix} ]}^{T} . & ( 8 )\end{matrix}$$

The “t” is a real number parameter the value of which ranges from zero to one. Qᵢ[t] equals to Pᵢ₋₂ when t=0. Qᵢ[t] equals to Pᵢ₋₁ when t=1. According to formula (6), (7) and (8), curve function Qᵢ[t] can be derived as a third order polynomial:

$${Q}_{i} [ t ] = \frac{1}{2} [ ( - {t}^{3} + 2 {t}^{2} - t ) {P}_{i - 3} + ( 3 {t}^{3} - 5 {t}^{2} + 2 ) {P}_{i - 2} + ( - 3 {t}^{3} + 4 {t}^{2} + t ) {P}_{i - 1} + ( {t}^{3} - {t}^{2} ) {P}_{i} ] \qquad ( 9 )$$

For example, processing unit adopts 0.01 as Δt to interpolate edge sample pixels. In other words, processing unit 1 generates interpolated pixel coordinates by substituting the value of “t” in the polynomial from t=0 to t=1 augmenting the value of t by 0.01 to for each substitution.

For example, acquiring four edge sample pixels, (100, 100), (500, 1000), (900, 300) and (1200, 1200), processing unit 1 generates an interpolated pixel coordinate (x, y) by substituting t=0.5 into the polynomial (9). Derivation of (x, y) is described in the following:

$$\begin{matrix}x = 1 / 2 ( ( - 0.5 \times 0.5 \times 0.5 + 2 \times 0.5 \times 0.5 - 0.5 ) \times 100 + \\ ( 3 \times 0.5 \times 0.5 \times 0.5 - 5 \times 0 , 5 \times 0.5 + 2 ) \times 500 + \\ ( - 3 \times 0.5 \times 0.5 \times 0.5 + 4 \times 0.5 \times 0.5 + 0.5 ) \times 900 + \\ ( 0.5 \times 0.5 \times 0.5 - 0.5 \times 0.5 ) \times 1200 ) \\ = 1 / 2 ( - 0.125 \times 100 + 1.125 \times 500 + 1.125 \times \\ 900 - 0.125 \times 1200 ) \\ = 706 \\ y = 1 / 2 ( ( - 0.5 \times 0.5 \times 0.5 + 2 \times 0.5 \times 0.5 - 0.5 ) \times 100 + \\ ( 3 \times 0.5 \times 0.5 \times 0.5 - 5 \times 0 , 5 \times 0.5 + 2 ) \times 1000 + \\ ( - 3 \times 0.5 \times 0.5 \times 0.5 + 4 \times 0.5 \times 0.5 + 0.5 ) \times 300 + \\ ( 0.5 \times 0.5 \times 0.5 - 0.5 \times 0.5 ) \times 1200 ) \\ = 1 / 2 ( - 0.125 \times 100 + 1.125 \times 1000 + 1.125 \times \\ 300 - 0.125 \times 1200 ) \\ = 650\end{matrix}$$

Thus, processing unit 1 acquires an interpolated pixel (706, 650) between the edge sample pixels (500, 1000) and (900, 300). Processing unit 1 can generate and acquire a closed spline as a rough contour of the subject by interpolating every adjacent edge sample pixel as described above (step S25).

After acquiring the rough contour, processing unit 1 adjusts the rough contour according to an energy function. First, processing unit 1 re-samples every pixel of the rough contour. In the second embodiment of the invention, a search area is defined relative to a processed pixel of the rough contour. The search area comprises 15 pixels, 9 of which comprise a 3×3 rectangular area centered on the processed pixel, 3 of which extend upward from the middle pixel of the upper side of the 3×3 rectangular area, and 3 of which extend downward from the middle pixel of the lower side of the 3×3 rectangular area. FIG. 9 is a schematic diagram of a search area in the second embodiment of the invention. Pixel Q₂ is a pixel of rough contour 142 processed for contour adjustment. The search area relative to pixel Q₂ comprises 15 pixels as shown in FIG. 9. If the pixel coordinates Q₂ are (706, 650), the coordinates of the other 14 pixels are (706, 646), (706, 647), (706, 648), (706, 649), (706, 651), (706, 652), (706, 653), (706, 654), (705, 649), (705, 650), (705, 651), (707, 649), (707, 650) and (707, 651) respectively. Next, processing unit 1 calculates an energy value of the 15 pixels according to an energy function. If a pixel with the least energy value among the 15 pixels is different from the pixel Q₂, processing unit 1 adopts the least-energy-value pixel as a portion of the contour 142 to replace pixel Q₂. Thus, processing unit 1 adjusts the rough contour.

In the second embodiment of the invention, the energy function comprises a combination of four functions comprising a Laplacian operation, Sobel operation, and curvature and continuity evaluation functions. The energy function can be represented as the following:
F_{Energy}(P)=w₁×f_{LAP}(P)+w₂×f_{Sobel}(P)+w₃×f_{Cur}(P)+w₄×f_{Con}(P) (10)

P is a pixel within a search area, and w₁, w₂, w₃, and w₄ are weight values. f_{LAP}(P) and f_{Sobel}(P) are Laplacian and Sobel operations of the pixel P respectively. f_{Cur}(P) represents the curvature evaluation function related to the pixel P and neighboring edge sample pixels thereof. f_{Con}(P) represents continuity evaluation functions of the pixel P and neighboring edge sample pixels thereof.

Laplacian operation f_{LAP}(P) and Sobel operation f_{Sobel}(P) of the pixel P may implement formulas (2) and (4) as described above. Thus detailed description thereof is omitted. f_{Cur}(P) evaluates curvature of the pixel P and neighboring pixels of the contour. The less the value of f_{Cur}(P), the more smooth the adjusted contour. Provided two pixels (x₁, y₁) and (x₃, y₃) of the contour 142 adjacent to pixel P(x, y), the curvature evaluation functions f_{Cur}(P) Of the pixel P(x, y) may be represented as the following:

$${f}_{Cur} ( P ) = \vert \frac{( {x}_{3} - x , {y}_{3} - y )}{\sqrt{{( {x}_{3} - x )}^{2} + {( {y}_{3} - y )}^{2}}} - \frac{( x - {x}_{1} , y - {y}_{1} )}{\sqrt{{( x - {x}_{1} )}^{2} + {( y - {y}_{1} )}^{2}}} \vert . \qquad ( 11 )$$

f_{Con}(P) evaluates continuity of the pixel P and a neighboring pixel of the contour. Provided a previously processed pixel (x₁, y₁) of the contour adjacent to pixel P(x, y), the continuity evaluation functions f_{Con}(P) of the pixel P(x, y) may be represented as the following:
f_{Con}(P)=(x−x₁)²+(y−y₁)² (12)

For example, processing unit 1 substitutes P(x, y) in formulas (2) and (4) by Q₂(706, 650) to calculate f_{LAP}(Q₂) and f_{Sobel}(Q₂) and substitutes (x₁, y₁) and (x₃, y₃) in formulas (11) and (12) with (500, 100) and (900, 300) to calculate f_{Cur}(Q₂) and f_{Con}(Q₂) . Note that (x_{1, y}₁) and (x₃, y₃) may be substituted by other pixels of the contour 142 near and excluded from the search area.

Processing unit 1 calculates the energy value of all the pixels within the search area according to the energy function formula (10). Processing unit 1 compares energy values of all pixels within the search area to determine whether to replace pixel Q₂. Thus, processing unit 1 adjusts the rough contour.

Processing unit 1 re-samples each pixel of the rough contour in the re-sample process as previously described. After re-sampling each pixel of the rough contour, processing unit 1 acquires an adjusted contour. Note that the energy function may be amended variously.

Processing unit 1 then extracts the subject from the first image based on the adjusted contour (step S27). Specifically, processing unit 1 adopts the adjusted contour as a mask, extracts pixels of the first image within the mask as an extracted subject and clears pixel excluded from the mask as a background.

Processing unit 1 stores the extracted subject in memory 4 (step S3) and displays the extracted subject on display 5 via an application (step S4). For example, memory 4 stores the application, such as a video game program. When executing the application, processing unit 1 is directed by the application to display the extracted subject on display 5.

Processing unit 1 extracts, stores and inputs different extracted subjects to the application for display. The application may be implemented by circuits.

Because the background image has been removed, the extracted subject can be used as an animated object in a video game program, wherein the animated object performs motion relative to a background of the video game program or changes appearance, such as fading in or fading out. The extracted subject may replace cursor icons or others of a GUI of any application as desired. Different extracted subjects may generate a video clip without a background.

The subject extraction step of the second embodiment of the invention is illustrated in the following example.

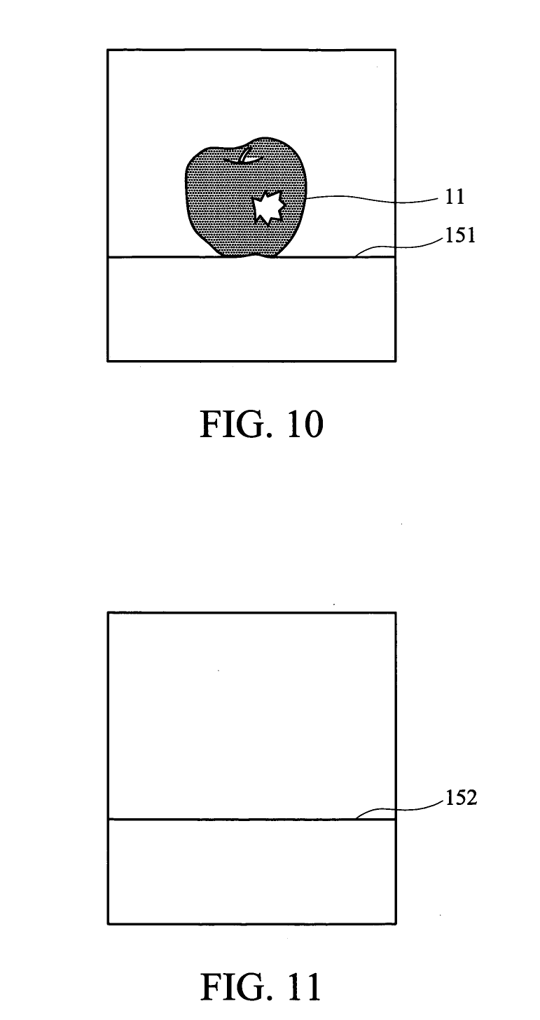

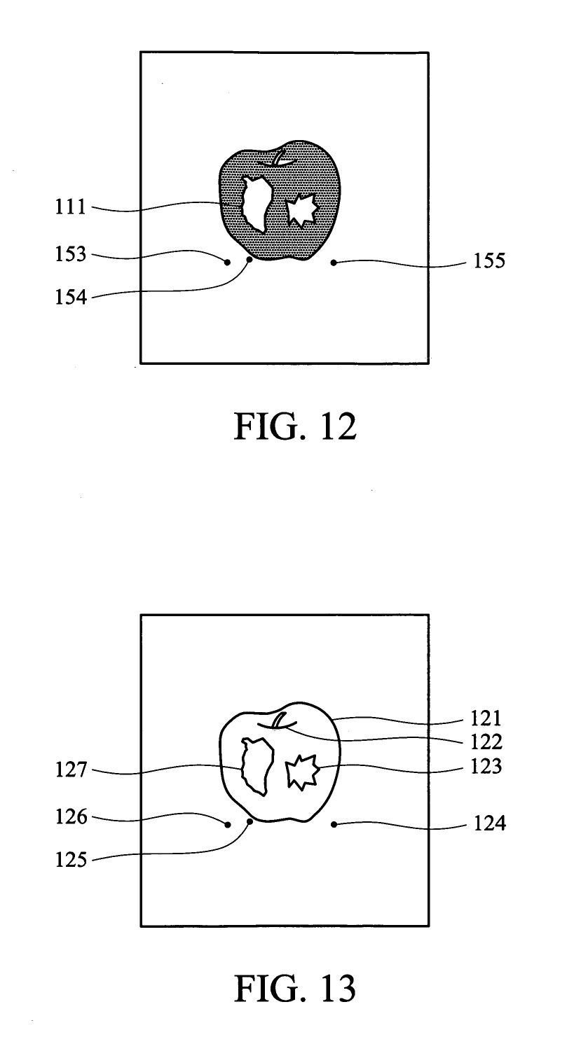

FIG. 10 is a schematic diagram of a first image captured by digital camera 10 triggering flash 3. The first image comprises subject 11 and a background. The background comprises line 151. After the subject is removed, digital camera 10 triggers flash 3 and captures a second image as shown in FIG. 11. The second image comprises line 152. If not moved during capture of the first and the second images, digital camera 10 directly subtracts the second image from the first image to generate a foreground-enhanced image without adjusting the relative positions of the first and second images. FIG. 12 is a schematic diagram of the foreground-enhanced image, wherein the line 151 is almost removed except for spots 153-155. A portion of the subject 11 the primary color values of which approximate the background image of the second image causes a blank area 111. Digital camera 10 performs edge enhancement on the foreground-enhanced image to generate an edge-enhanced image as shown in FIG. 13.

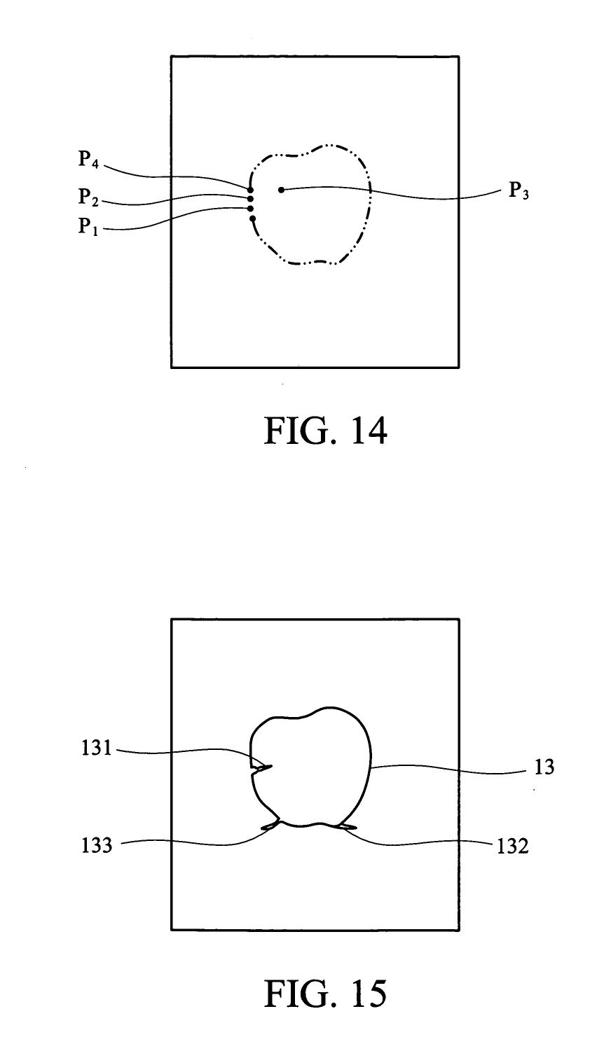

FIG. 13 is a schematic diagram of the edge-enhanced image comprising edges 121-127. Digital camera 10 collects edge sample pixels of the edge-enhanced image in specific directions from outer portions to inner portions of the edge-enhanced image. Edges 122, 123 and 127 within edge 121 are excluded from the collected edge sample pixels as shown in FIG. 14.

FIG. 14 is a schematic diagram of the collected edge sample pixels. Digital camera 10 interpolates the collected edge sample pixels. For example, pixels P₁, P₂, P₃ and P₄ are interpolated to generate a continuous curve as Pᵢ₋₃, Pᵢ₋₂, Pᵢ₋₁, Pᵢ. After all edge sample pixels are interpolated to generate a closed spline, the closed spline is acquired as a rough contour 13 of subject 11 as shown in FIG. 15.

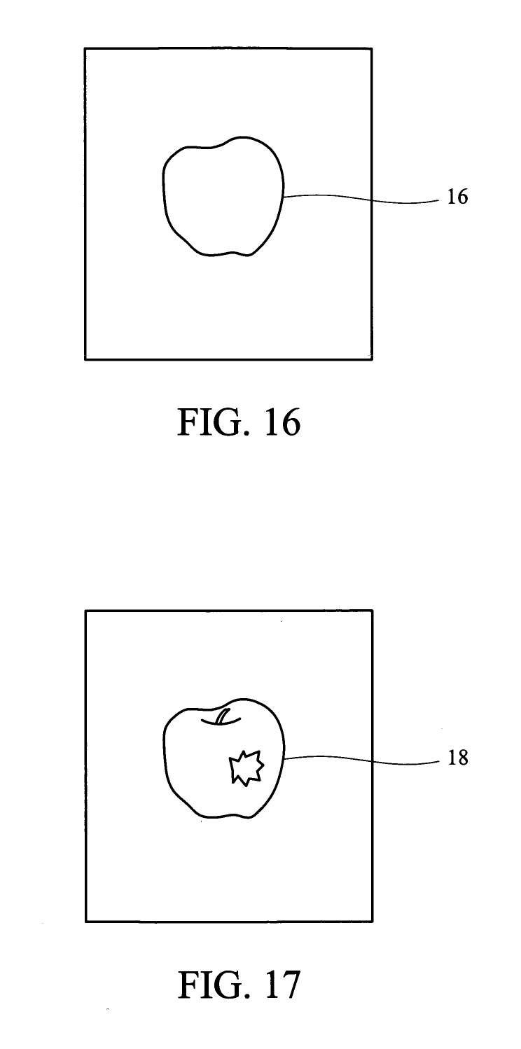

FIG. 15 is a schematic diagram of rough contour 13 comprising spikes 131-133. Digital camera 10 re-samples every pixel of rough contour 13 based on the previously-described energy function to generate adjusted contour 16 as shown in FIG. 16 suitable for subject 11. Spikes 131-133 are smoothed after the adjustment.

FIG. 16 is a schematic diagram of adjusted contour 16. Digital camera 10 extracts area 18 from the first image according to adjusted contour 16 without shifting relative positions of adjusted contour 16 and the first image. Adjusted contour 16 is used as a mask on the first image. Pixels included in adjusted contour 16 are extracted to be area 18 as shown in FIG. 17. Area 18 approximates subject 11. Digital camera 10 stores subject 18 as an extracted subject.

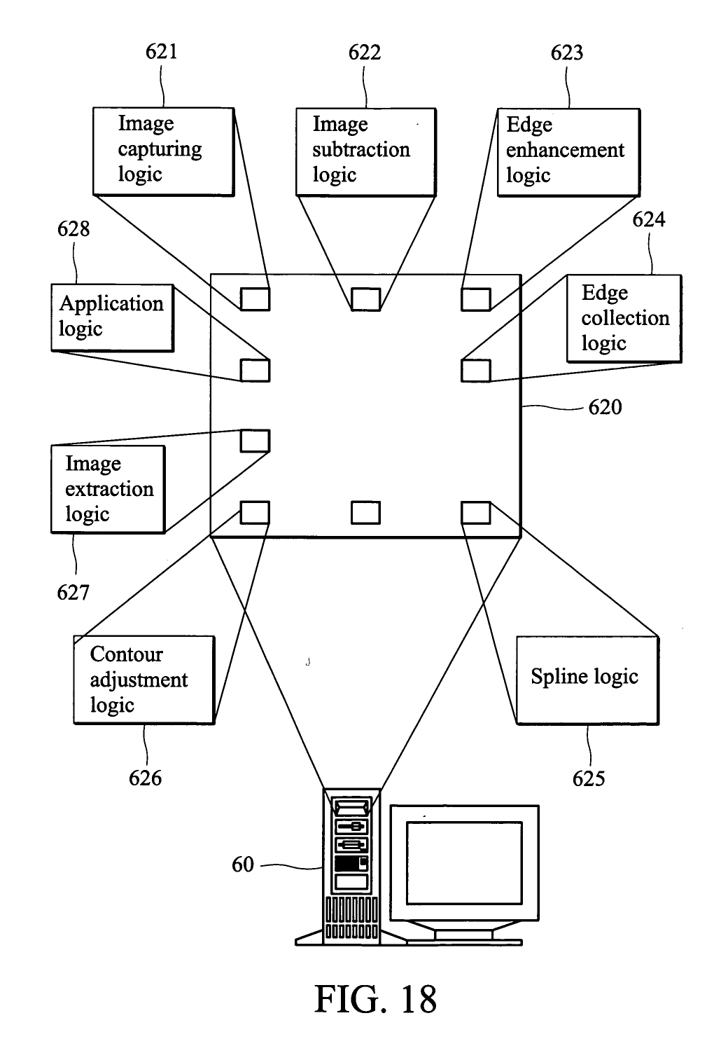

FIG. 18 is a schematic diagram of the storage medium of the invention. Storage medium 60 stores a computer program 620 for implementing the specific image extraction method of the invention. The computer program 620 comprises image capturing logic 621, image subtraction logic 622, edge enhancement logic 623, edge collection logic 624, spline logic 625, contour adjustment logic 626, image extraction logic 627 and application logic 628.

Image capturing logic 621 captures images, such the first and second image. Image subtraction logic 622 performs image subtraction, such as subtracting the second from the first image. Edge enhancement logic 623 enhances edges in the result of the image subtraction. Edge collection logic 624 collects proper edge pixels. Spline logic 625 interpolates the collected edge pixels to generate a spline. Contour adjustment logic 626 adjusts the spline to be an adjusted contour. Image extraction logic 627 extracts a specific image from at least one captured image. Application logic 628 reveals the extracted specific image.

Hence, the method and image capture device according to the invention extract a specific image area from captured images for subsequent application.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A specific image extraction method, implemented in an image capture device, comprising the steps of:
capturing a first image and a second image, wherein only the first image comprises a subject;
generating a third image from the difference of the first and the second image;
enhancing edges of the third image to generate a fourth image;
extracting a contour from the fourth image;
adjusting the contour;
extracting the subject based on the adjusted contour; and
displaying the extracted subject using an application executed in the image capture device.

2. The method as claimed in claim 1, further comprising the steps of triggering a flash of the image capture device respectively when capturing the first and the second image.

3. The method as claimed in claim 1, wherein the enhancing step further comprises the steps of:
generating a first edge-enhanced image and a second edge-enhanced image using the Laplacian and the Sobel algorithms respectively; and
adding the first edge-enhanced image and the second edge-enhanced image respectively weighted with weight values to generate the fourth image.

4. The method as claimed in claim 3, wherein the operator of the Laplacian algorithm is
$$[ \begin{matrix}0 & - 1 & 0 \\ - 1 & 4 & - 1 \\ 0 & - 1 & 0\end{matrix} ] .$$

5. The method as claimed in claim 3, wherein the operators of the Sobel algorithm are
$$[ \begin{matrix}- 1 & - 2 & - 1 \\ 0 & 0 & 0 \\ 1 & 2 & 1\end{matrix} ] and [ \begin{matrix}- 1 & 0 & 1 \\ - 2 & 0 & 2 \\ - 1 & 0 & 1\end{matrix} ] .$$

6. The method as claimed in claim 1, wherein the contour extraction step further comprises the steps of:
collecting edge sample pixels in specific directions from the outer portion to the central portion of the fourth image; and
interpolating the collected edge sample pixels to generate the contour.

7. The method as claimed in claim 6, wherein the interpolating step further comprises the steps of:
determining a curve function Qᵢ[t]=TMGᵢ based on four collected edge sample pixels Pᵢ₋₃, Pᵢ₋₂, Pᵢ₋₁, Pᵢ,
wherein T=[t³t²t¹ 1],
$$M = \frac{1}{2} [ \begin{matrix}- 1 & 3 & - 3 & 1 \\ 2 & - 5 & 4 & - 1 \\ - 1 & 0 & 1 & 0 \\ 0 & 2 & 0 & 0\end{matrix} ] ,$$
Gᵢ=[Pᵢ₋₃ Pᵢ₋₂ Pᵢ₋₁ pᵢ]^{T}, and t is a real number between 0 and 1; and
generating a curve between collected edge sample pixels Pᵢ₋₂ and Pᵢ₋₁ based on the curve function.

8. A method as claimed in claim 1, wherein the adjustment step further comprises the steps of:
acquiring a coordinate of a pixel of the contour;
calculating energy values of all pixels within a search area related to the acquired pixel using an energy function comprising a combination of a Laplacian operation, a Sobel operation, and curvature and continuity evaluation based on a processed pixel; and
adopting a calculated pixel comprising the minimum energy value as an adjusted pixel of the contour to replace the acquired pixel.

9. The method as claimed in claim 8, wherein the search area comprises 15 pixels, 9 of which comprise a 3×3 rectangular area centered on the processed pixel, 3 of which extend upward from the middle pixel of the upper side of the 3×3 rectangular area, and 3 of which extend downward from the middle pixel of the lower side of the 3×3 rectangular area.

10. The method as claimed in claim 8, wherein the energy function comprising a weighted sum of a Laplacian function, a Sobel function, a curvature function and a continuity function based on a calculated pixel.

11. The method as claimed in claim 1, wherein the application comprises a video game program.

12. A machine-readable storage medium storing a computer program which, when executed, directs a computer to perform a specific image extraction method as claimed in claim 1.

13. A specific image extraction method, implemented in an image capture device comprising a touch panel and an application, comprising the steps of:
capturing a first image comprising a subject;
acquiring a contour through the touch panel;
extracting the subject based on the contour; and
displaying the extracted subject using the application executed in the image capture device.

14. The method as claimed in claim 13, wherein the application comprises a video game program.

15. A machine-readable storage medium storing a computer program which, when executed, directs a computer to perform a specific image extraction method as claimed in claim 14.

16. An image capture device, comprising:
an image capture unit capturing a first image and a second image, wherein only the first image comprises a subject;
a processing unit coupled to the image capture unit, generating a third image from the difference of the first and the second image, enhancing edges of the third image to generate a fourth image, extracting a contour from the fourth image, adjusting the contour, and extracting the subject based on the adjusted contour; and
a display coupled to the processing unit, displaying the extracted subject using an application executed in the image capture device.

17. The device as claimed in claim 16, further comprising a flash coupled to the processing unit, wherein the flash is triggered respectively when the image capture unit is capturing the first and the second images.

18. The device as claimed in claim 16, wherein the application comprises a video game program.

19. The device as claimed in claim 16, wherein the image capture device is a mobile device.

20. An image capture device, comprising:
an image capture unit capturing a first image comprising a subject;
a touch panel providing a contour of the subject according to user operation;
a processing unit coupled to the image capture unit and the touch panel, acquiring the contour from the touch panel and extracting the subject based on the contour; and
a display coupled to the processing unit, displaying the extracted subject using an application executed in the image capture device.

21. The device as claimed in claim 20, wherein the image capture device is a mobile device.
